(19) United States
(12) Patent Application Publication
(10) Pub. No.: US 2016/0110516 A1
(43) Pub. Date: Apr. 21, 2016

(54) DYNAMIC MONITORING EARLY CANCER RISK

(71) Applicants: Liwei Ma, Issaquah, WA (US); Charles Wang Ma, Issaquah, WA (US)

(72) Inventors: Liwei Ma, Issaquah, WA (US); Charles Wang Ma, Issaquah, WA (US)

(21) Appl. No.: 14/518,922

(22) Filed: Oct. 20, 2014

(51) Int. Cl. G06F 19/00

(52) U.S. Cl. CPC G06F 19/3431; G06F 19/363

(57) ABSTRACT

Disclosed are a method and a system for monitoring early cancer risk. Most current early cancer detection and diagnosis are related with gene and biomarkers, although the practice has proven the significant differences of blood and urine test results between cancer patients and healthy people, and obtaining the results of routine blood and urine tests is not difficult, the use of routine blood and urine tests to detect and monitor early cancer risk has never been reported; and traditionally, early cancer detection and monitoring have been managed by doctors and hospitals, the users are unable to do it themselves. The purpose of this invention is to provide an early cancer risk monitoring system enabling users to dynamic monitor the early cancer risk.

### CROSS-REFERENCE TO RELATED APPLICATIONS

Not Applicable

### BACKGROUND OF THE INVENTION

Cancer is a leading cause of death worldwide, accounting for 8.2 million deaths in 2012. The most common causes of cancer death are cancers of: lung (1.59 million deaths), liver (745 000 deaths), stomach (723 000 deaths), colorectal (694 000 deaths), breast (521 000 deaths) and esophageal cancer (400 000 deaths). More than 30% of cancer deaths could be prevented by modifying or avoiding key risk factors, including: tobacco use, being overweight or obese, unhealthy diet with low fruit and vegetable intake, lack of physical activity, alcohol use and urban air pollution [1].

Prevention offers the most cost-effective long-term strategy for the control of cancer. An effective early cancer risk monitor system could save at least 2.7 million lives.

Blood test has long been used in the cancer research field, a Chinese group of researchers in 1996 found that the group of cancer patients had significant lower level of HCT than the group of healthy people [2].

A simple urine test could be used to detect certain cancers early, according to researchers. Proteins found in the urine of patients with advanced-stage stomach, gut and pancreatic cancers could help diagnose the disease in people who have yet to display symptoms [3].

Most current early cancer detection and diagnosis are related with gene and biomarkers, for example, “METHOD FOR EARLY DIAGNOSIS OF LIVER CANCER” by Wang, H. D. et al. [4], “METHOD FOR DETERMINING CANCER PROGNOSIS AND PREDICTION WITH CANCER STEM CELL ASSOCIATED GENES” by Goldkorn, A. [5], “Methods of predicting cancer risk using gene expression in premalignant tissue” by Cowen, et al. [6], “BREAST CANCER DIAGNOSTICS” by Penninger, J. et al. [6], and “METHODS AND BIOMARKERS FOR ANALYSIS OF COLORECTAL CANCER” by Lothe, R. A. et al. [7].

Although the researchers have identified significant differences of blood and urine test results between cancer patients and healthy people, and obtaining the results of routine blood and urine tests is not difficult, the use of routine blood and urine test results to detect and monitor early cancer risk has never been reported; and traditionally, early cancer detection and monitoring have been managed by doctors and hospitals, the users are unable to do it themselves.

### REFERENCES CITED

### U.S. Patent Documents

1. 20140099647 (Apri 2014) by Wang et al.
2. 20130260384 (October 2013) by Goldkorn A.
3. 20100291573 (November 2010) by Cowens, et al.
4. 20130316374 (November 2013) by Penninger et al.
5. 20140302100 (October 2014) by Lothe et al.

### Other References

1. World Health Organization (WHO) and Cancer, http://www.who.int/mediacentre/factsheets/fs297/en/2.
2. Wang, Y. L., Wang, X. Z., Du, Y. X., Li, S. M., Wang, F. T., Xu, D. K.: Observation of Hemorheology of patients with malignant tumor. Modern Journal of integrated traditional Chinese and Western Medicine, 5-02 (1996), P 129.
3. Husi, H., Stephens, N., Cronshaw, A., MacDonald, A., Gallagher, I., Greig, C., Fearon, K. C. H., Ross, J. A.: Proteomic analysis of urinary upper gastrointestinal cancer markers. Journal PROTEOMICS—Clinical Applications, Vol. 5, 5-6(2011), P 289-299.

### BRIEF SUMMARY OF THE INVENTION

At present about 90% of early cancers have no obvious symptoms, so that 80% of the diagnosed cancer patients are in the later stage. Conventional imaging, cell pathology, and protein biomarkers detection have been widely used to detect early cancers, but the detection results basically are advanced cancers with little chance of cure. Those detections are usually applied to relapsed cancer patients and for doctors to estimate a cancer patient's prognosis and they do not apply to early cancer detection.

This disclosure describes a method and a system using routine blood and urine tests result to predict the probabilities of the early cancer risk and help users monitoring early cancer risk.

In some embodiments, the method for provide users early cancer monitoring system comprises steps of: (A) Collecting user demographic and basic wellness panel data; (B) Predicting the probabilities of early cancer risk; (C) Analyzing and evaluating the probabilities of early cancer risk; (D) Generating and delivering the early cancer risk analysis report based user's gender, predicted probabilities and comparison results; (E) Monitoring the early cancer risk.

In other embodiments, the system for provide users early cancer monitoring system comprises: one or more CPU processors, and RAM communicatively coupled to the one of more CPU processors for storing: (A) A data processing module that aggregates demographic data and basic wellness panel data at user level and transforms the data; (B) An analytics module that analyzes the calculated early cancer risk probabilities, compares probabilities between different cancers and users and then rank users by probabilities in each cancer type; (C) An early cancer risk monitoring platform that dynamical collects user demographic and basic wellness panel data and delivers the early cancer risk analysis report through the user interface to help user monitor early cancer risk.

One object of the present invention is to provide a method for users to monitor early cancer risk.

Another object of the present invention is to provide a system for users to monitor early cancer risk.

The embodiments of the present invention are further described through below detailed examples and the drawings.

### BRIEF DESCRIPTION OF THE SEVERAL VIEWS OF THE DRAWINGS

FIG. 1 is a diagram showing an example system including a user, a user device, one or more networks, and one or more cloud servers. In this system, early cancer risk analysis report may be provided to the users based on user demographic and basic wellness panel data.

FIG. 2 is a diagram showing an example process of user accessing cancer risk monitoring platform and providing demographic, CBC, CMP, lipids and urinalysis data; Cloud database collects user data and transforms the data into different data files.

FIG. 3 is a diagram showing an example process of aggregating data, determining probabilities, comparing and evaluating probabilities and generating early cancer risk analysis report by the cloud server.

FIG. 4 is a diagram showing a user interface used to display early cancer risk analysis report to one or more users based on user's gender, calculated probabilities and comparison results.

FIG. 5 is a diagram showing an example process of collecting user data and providing early cancer risk analysis reports to users based on that data.

### DETAILED DESCRIPTION OF THE INVENTION

The description begins with a section, entitled “Example Environment”, describing a system for delivering early cancer risk analysis report to users and/or user devices monitoring early cancer risk. Next, the description includes a section entitled “Data Collection”, describes a system for collecting user demographic and basic wellness panel data. A “Prediction” section then follows, which describes using predictive models to determining early cancer risk probabilities. Next, the description includes an “Analysis and Evaluation” section that describes the process to compare and evaluate the probabilities. Then, the description includes a “Generating and Delivering” section that describes how the early cancer risk analysis reported is generated and displayed. The discussion then includes a section, entitled “Example Processes,” that illustrates and describes example processes for implementing the described techniques. Lastly, the description includes a brief “Conclusion”.

### Example Environment

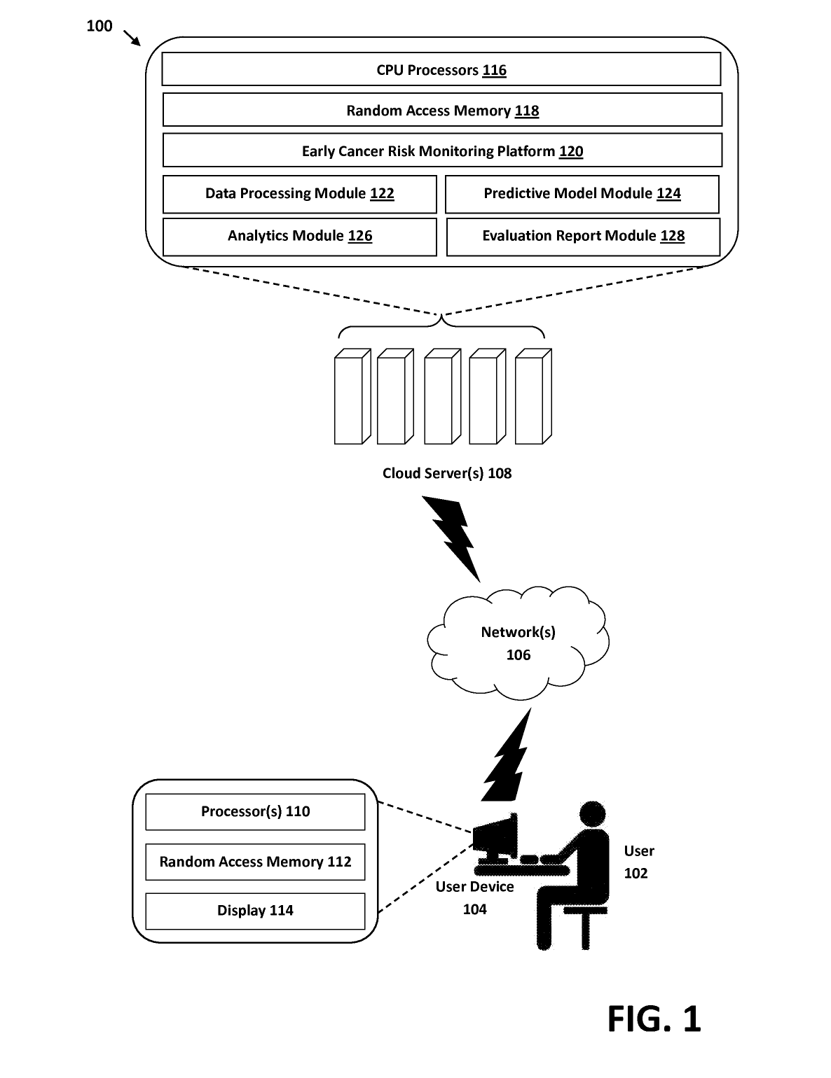

FIG. 1 illustrates an early cancer risk monitoring architecture 100 in which a user 102 may electronically access Early Cancer Risk Monitoring Platform (Platform) 120 and signup or login to the Platform 120 on a user device 104. As described below, the user device 104 may be implemented in any number of ways, such as a computer, a laptop computer, a tablet device, a personal digital assistant (PDA), a multi-functioning communication device, a smart TV box, and so on. The user 102 may access the Platform 120 over a network 106, such as the Internet, which may be communicatively coupled to one or more cloud server(s) 108. The cloud server(s) 108 may store various versions of Platform 120, such as web, mobile, tablet, and other types of Platform that are accessible by the user device. For instance, the user 102 may access the Platform 120 via one or more sites (e.g., a web site) that are accessible via the network(s) 106. One or more CPU processor(s) 116 and a Random Access Memory (RAM) 118 of the cloud server(s) 108 may allow the Platform 120 to generate and display the early cancer risk analysis report to the user 102. More particularly, a data processing module 122, a predictive model module 124, an analytics module 126, and an evaluation report module 128 are stored in RAM 118 and executed by the CPU processor(s) 116 to enable the Platform 120 to generate and display the early cancer risk analysis report to the user 102 based at least in part on user data.

The user 102 may access the Platform 120 in any of a number of different manners. For instance, the user 102 may access a site (e.g., a web site) associated with an entity, such as a hospital, that provides access to the Platform 120. Such a site may be remote from user device 104 but may allow user 102 to interact with the Platform 120 via the network(s) 106. Moreover, the user 102 may download one or more applications to the user device 104 in order to access to the Platform 120.

In some embodiments, the user device 104 may be any type of device that is capable of receiving, accessing, and/or interacting with the Platform 120, such as, for example, a personal computer, a laptop computer, a cellular telephone, a personal digital assistant (PDA), a tablet device, an electronic book (e-Book)) reader device, a television, or any other device that may be used to access Platform 120 by the user 102. The user device 104 shown in FIG. 1 is only one example of a user device 104 and is not intended to suggest any limitation as to the scope of use or functionality of any user device 104 utilized to perform the processes and/or procedures described herein.

The processor(s) 110 of the user device 104 may execute one or more modules and/or processes to cause the user device 104 to perform a variety of functions, as set forth above and explained in further detail in the following disclosure. In some embodiments, the processor(s) 110 may include a central processing unit (CPU), a graphics processing unit (GPU), both CPU and GPU, or other processing units or components known in the art. For instance, the processor(s) 110 may allow the user device 104 to access sites and/or download applications that are used to access the Platform 120. Additionally, each of the processor(s) 110 may possess its own local memory, which also may store program modules, program data, and/or one or more operating systems.

In at least one configuration, the Random Access Memory (RAM) 112 of the user device 104 may include any component that may be used to access the Platform 120. Depending on the exact configuration and type of the user device 104, the RAM 112 may also include volatile memory, non-volatile memory (such as ROM, flash memory, miniature hard drive, memory card, or the like) or some combination thereof.

In various embodiments, the user device 104 may also have input device(s) such as a keyboard, a mouse, a pen, a voice input device, a touch input device, etc. The user device 104 may also include the display 114 and other output device(s), such as speakers, a printer, etc. The user 102 may utilize the foregoing features to interact with the user device 104 and/or the cloud server 108 via the network(s) 106. More particularly, the display 114 of the user device 104 may include any type of display known in the art that is configured to present (e.g., display) information to the user 102. For instance, the display 114 may be a screen or user interface that allows the user 102 to access the Platform 120.

In some embodiments, the network(s) 106 may be any type of network known in the art, such as the Internet. Moreover, the user device 104 and the cloud server(s) 108 may communicatively couple to the network(s) 106 in any manner, such as by a wired or wireless connection. The network(s) 106 may also facilitate communication between the user device 104 and the cloud server(s) 108, and also may allow for the transfer of data or communications between. For instance, the cloud server(s) 108 and/or other entities may provide access to the Platform 120 that may be accessed utilizing the user device 104.

In addition, and as mentioned previously, the cloud server(s) 108 may include one or more CPU processor(s) 116 and a RAM 118, which may include the Platform 120, the data processing module 122, the predictive model module 124, the analytics module 126, and the evaluation report module 128. The cloud server(s) 108 may also include additional components not listed above that perform any function associated with the cloud server(s) 108. In various embodiments, the cloud server(s) 108 may be any type of server, such as a network-accessible server, or the cloud server(s) 108 may be any entity that provides access to the Platform 120 that is stored on and/or is accessible by the cloud server(s) 108.

### Data Collection

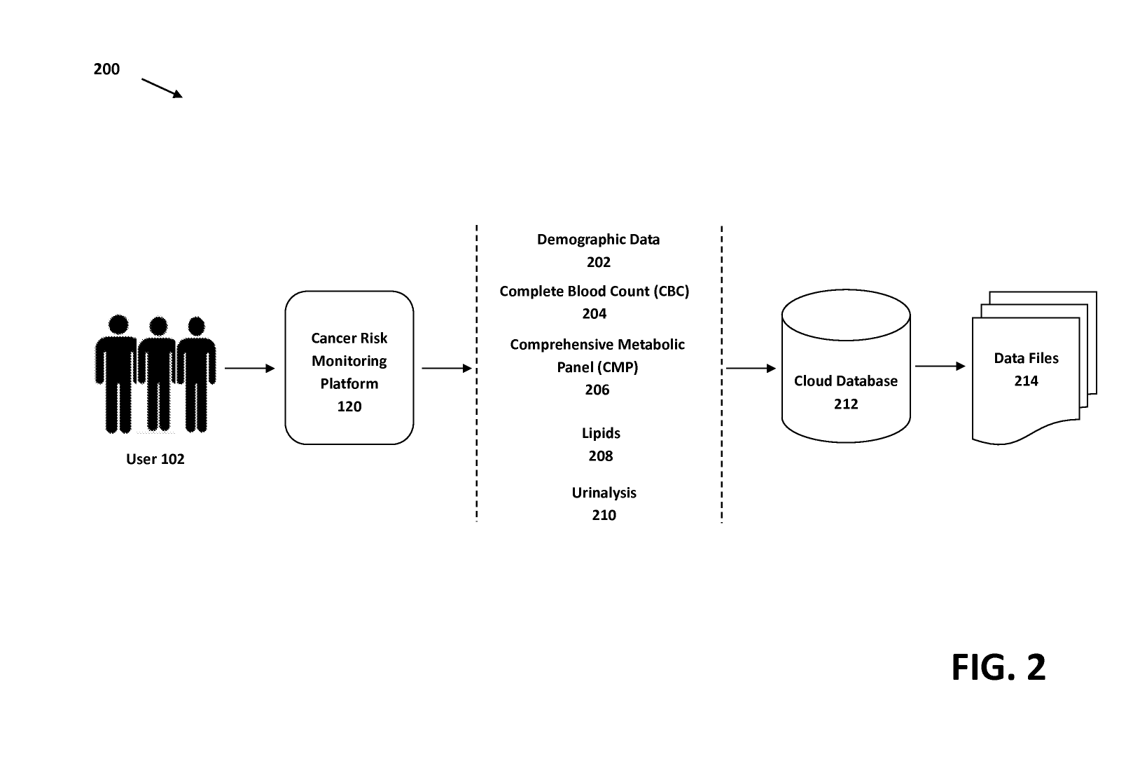

FIG. 2 illustrates a data collection process 200 in which the data being collected is provided directly from the user 102. For example, the user 102 may login to the Platform 120 to provide information about the user 102 which may include demographic data 202 about the user 102, such as age and gender, and basic wellness panel data such as CBC 204, CMP 206, lipids 208, Urinalysis data 210, etc. The collected data may be stored by the cloud database 212 inside the cloud server(s) 108, the cloud database 212 may output data files 214.

In some embodiments, the demographic data 202 provided by the user 102 may include age, gender, height, weight, or any other personal information; The CBC 204 provided by the user 102 may include White Blood Cell Count (WBC), Red Blood Cell Count (RBC), Red Cell Distribution Width (RDW), Hematocrit (HCT), Hemoglobin (HGB), Mean Corpuscular Volume (MCV), Mean Corpuscular Hemoglobin (MCH), Mean Corpuscular Hemoglobin Concentration (MCHC), Platelet (MPV), Percentage and absolute differential counts for types of WBC's including neutrophils, lymphocytes, monocytes, eosinophils, and basophils, or any other test that may be included in CBC 204 panel; The CMP 206 provided by the user 102 may include glucose, BUN, Creatinine, BUN/Creatinine Ratio, Estimated Glomerular Filtration Rate (eGFR), Sodium, Potassium, Chloride, Carbon Dioxide, Calcium, Total Protein, Albumin, Globulin, Albumin/Globulin Ratio, Total Bilirubin, Alkaline Phosphatase (ALP), Aspartate Amino Transferase (AST), Alanine Amino Transferase (ALT), or any other test that may be included in CMP 206 panel; The Lipid 208 provided by the user 102 may include Total Cholesterol (CHOL), HDL Cholesterol, LDL Cholesterol, Cholesterol/HDL Ratio, Triglycerides (TG), or any other test that may be included in Lipids 208 panel; The urinalysis 210 provided by the user 102 may include Protein (PRO), Glucose (GLU), Ketone bodies (KET), Bilirubin (BIL), Urobilinogen (URO), pH, Specific Gravity (SG), Occult Blood (BLD), VC, Leukocyte Esterase (LEU), Nitrite (NIT), or any other test that may be included in Urinalysis 210 panel.

In various embodiments, the cloud database 212 may be a relational database management system that may provide access to a number of different databases, for example, data processing module 122. In some embodiments, the cloud database 212 may be a MySQL relational database and/or a real-time database that includes multiple sources of data, such as the data processing module 122.

In other embodiments, the data files 214 generated by the cloud database 212 inside the cloud server(s) 108 may include user demographic file, CBC file, CMP file, Lipids file, Urinalysis file or any other file may be associated with the predictive purpose.

### Prediction

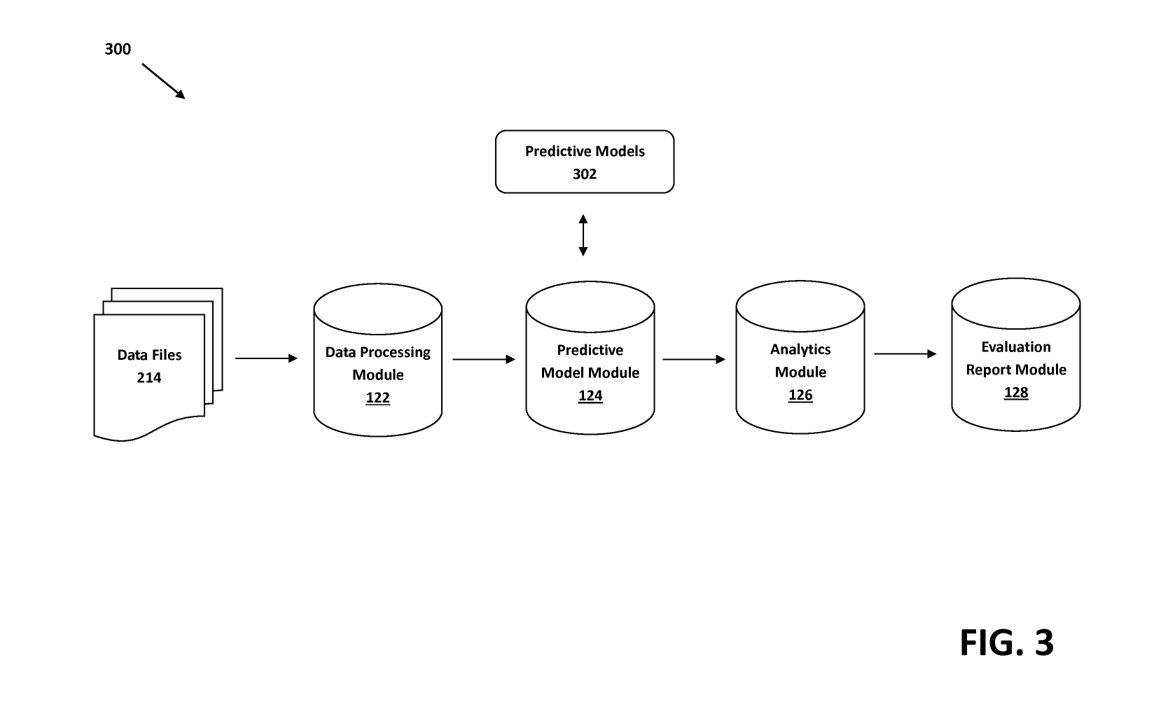

FIG. 3 illustrates a diagram showing various components and/or modules of the client server(s) 108. In some embodiments, As mentioned previously, the cloud server(s) 108 may be any type of server, a service provider, and/or a service that provides and/or facilitates users access to the Platform 120. Moreover, the cloud sever(s) 108 may include the data processing module 122, predictive model module 124, analytics module 126, evaluation report module 128, and predictive models 302. As stated previously, the cloud server(s) 108 may collect user demographic and basic wellness panel data, store data representative of such user health condition, process the data to generate predictive models 302, and/or utilize the predictive models 302 to predict which users 102 are likely to have higher cancer risk.

In various embodiments, the data processing module 122 may be a relational database management system that may provide access to a number of different databases, for example, cloud database 212. In some embodiments, the data processing module 122 may be a MySQL relational database and/or may be a production environment or a real-time database that includes multiple sources of data, such as the cloud database 212. Moreover, the data processing module 122 may store data that can be used to build a profile for each user 102. That is, each time a particular user 102 interacts with the cloud server(s) 108, such as by interacting with a site (e.g., a website) and/or an application utilizing the user device 104, the cloud server(s) 108 may store this data in the data processing module 122. Likewise, any user interaction with the Platform 120 may be represented by data that is stored in the data processing module 118.

The predictive model module 124 may calculate probabilities between the data provided by the data processing module 122 and may take the form of analytical software. Moreover, the predictive model module 124 may include or generate predictive models 302 for making predictions based at least in part on the data provided by the data processing module 122. The probabilities and predictive data generated by the predictive model module 124 may be determined using one or more algorithms, which will be discussed in additional detail below. In various embodiments, the predictive models 302 may be generated by the cloud server(s) 108 or the predictive model module 124. In other embodiments, the predictive models 302 may include lung cancer predictive model, stomach cancer predictive model, liver cancer predictive model, colorectal cancer predictive model, esophageal cancer predictive model, cervical cancer predictive model, breast cancer predictive model, or any other common cancer predictive model.

As mentioned previously, predictive models 302 and/or algorithms may be utilized by the predictive model module 124 to determine probabilities based at least in part on user 102 provided demographic data 202, CBC 204, CMP 206, Lipids 208, Urinalysis 210, or any other data may be needed by the predictive models. In some embodiments, the probabilities may be calculated utilizing Equation 1 and Equation 2, as shown below:

$$\begin{matrix}Logit [ p ( x ) ] = α + β 1 X 1 + β 2 X 2 + … + β n Xn & ( 1 ) \\ p = \frac{Exp ( α + β 1 X 1 + β 2 X 2 + … + β n Xn )}{1 + Exp ( α + β 1 X 1 + β 2 X 2 + … + β n Xn )} & ( 2 )\end{matrix}$$

In Equation 1 and 2, p is the probability of the outcome of interest or “event”, X is the predictor variables, α is the constant of the equation, which may represent the value of p when the values of predictor variables is zero. β is the coefficient of the predictor variables, and Exp is the base of natural logarithms (approx. 2.72). In some embodiments, Equation 1 and 2 together may provide probability to each of the cancers corresponding to the users 102. Furthermore, β1, β2, and βn may be various weighting coefficients and X1, X2, and Xn may present demographics data 202, CBA data 204, CMP data 206, Lipids data 208 or Urinalysis data 210. In various embodiments, β1X1, β2X2, and βnXn may be utilized to determine a particular user 102 is likely to have higher early cancer risk.

### Analysis and Evaluation

The predictive model module 124 may generate the output for Analytics module 126, the output my include one or more tables that represent probabilities for one or more cancers. In some embodiments, the tables may indicate probabilities for two or more variables (e.g., uses 102, user IDs, cancer, cancer IDs, gender, gender IDs, etc.).

The analytics module 126 may utilize the net lift algorithm, the equation 3, as shown below to determine a particular user 102 is likely to have a High, Medium, or Low early cancer risk.

Net Lift=(Pt−Pc)/Pc (3)

where Pt is a percentage of cancer patients in the target/test group and Pc is a percentage of cancer patients in the control group.

In some embodiments, The analytics module 126 may compare the real-time calculated probabilities by the predictive models 302 for a particular user 102 to the probabilities that are stored in the predictive model 302 to determine the High, Medium or Low risk for the user 102. The evaluation report module 128 may generate early cancer analysis report based at least in part on user demographic data 202 and the comparison results provided by the analytics module 126.

### Generating and Delivering

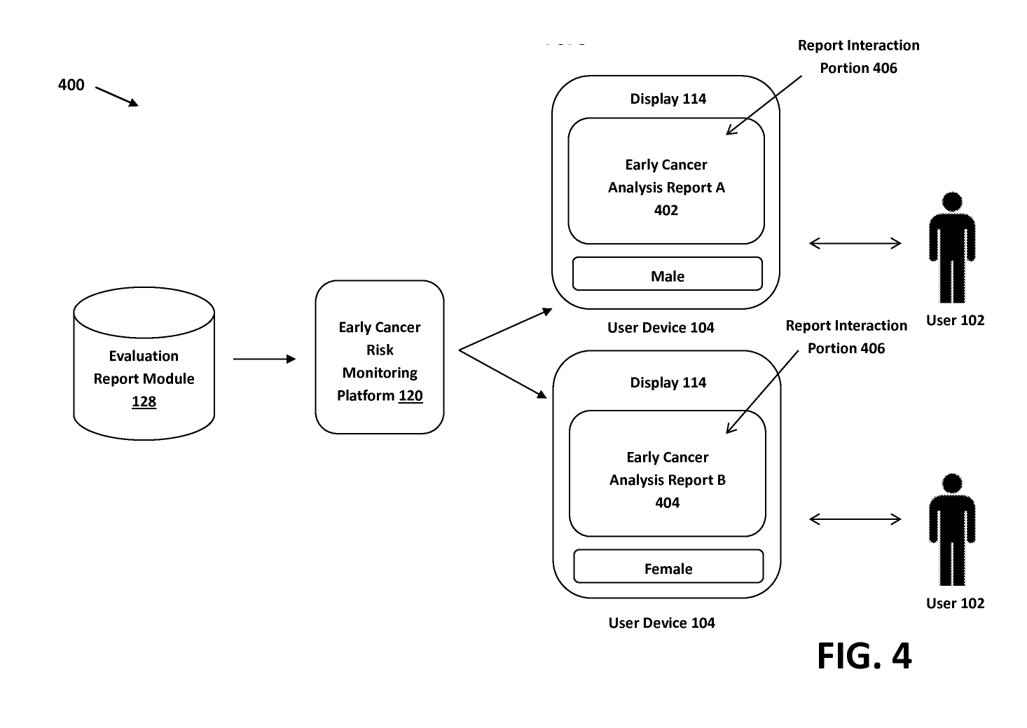

FIG. 4 illustrates a diagram representing a system 400 for generating and delivering early cancer risk analysis report to users 102. More particularly, the system 400 may include the evaluation report module 128, the early cancer risk monitoring platform 120, a user device 104, which may include a display 114. In some embodiments, the display 114 may include a report interaction portion 406. In various embodiments, then user 102 may access the early cancer analysis report A or B via an application that may be downloaded to and/or stored on the user device 104. In other embodiments, the user 102 may operate the user device 104 to access the early cancer analysis report A or B via a site (e.g., a website) that provided (or provides access to) the early cancer analysis report A or B. For the purposes of this discussion, the term “portion” may be interchangeably referred to a “window” or a “section.”

As shown, the evaluation report module 128 may generate early cancer analysis report A 402 based at least in part on user demographic data 202 (e.g., male) and comparison results. The evaluation report module 128 may deliver the report to the Platform 120 and the Platform 120 may display the early cancer analysis report A to the user 102 via the report interaction portion 406 on user device 104.

In some embodiments, the evaluation report module 128 may generate early cancer analysis report B 402 based at least in part on user demographic data 202 (e.g., female) and comparison results. The evaluation report module 128 may deliver the report to the Platform 120 and the Platform 120 may deliver the early cancer analysis report B to the user 102 via the report interaction portion 406 on user device 104.

### Example Processes

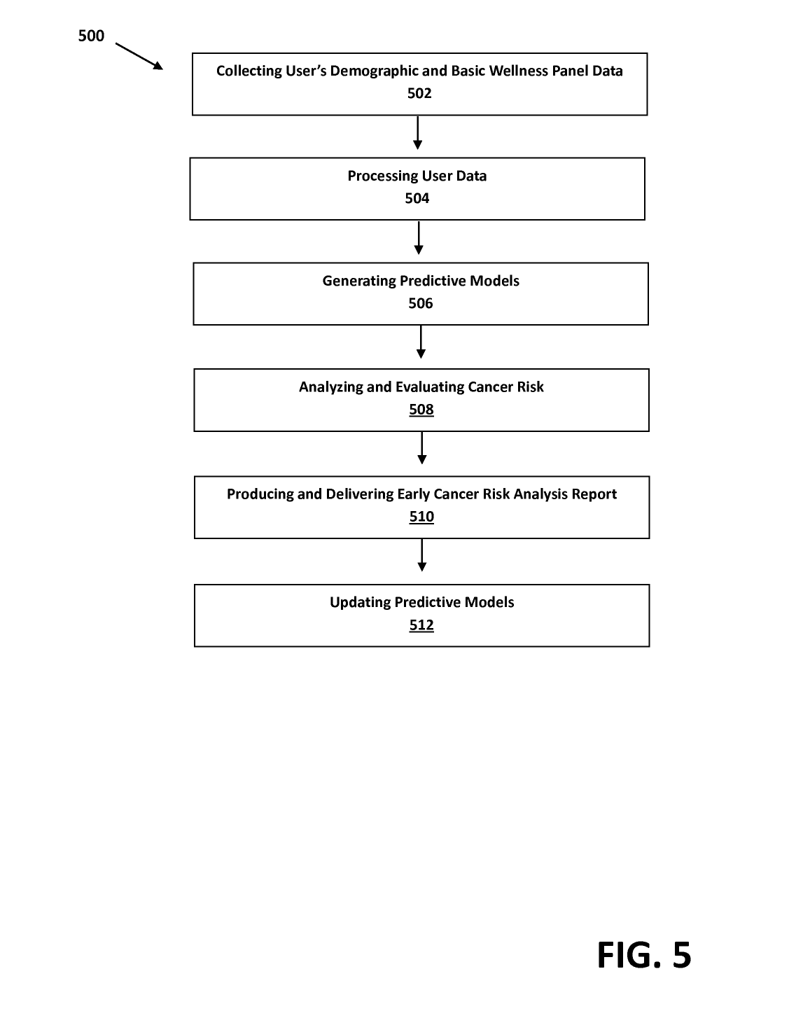

FIG. 5 describes various example processes of providing early cancer analysis report based at least in part on user provided data. The example processes are described in the context of the environment of FIGS. 1-5 but are not limited to those environments. The order in which the operations are described in each example method is not intended to be construed as a limitation, and any number of the described blocks can be combined in any order and/or in parallel to implement each method. Moreover, the blocks in FIG. 5 may be operations that can be implemented in hardware, software, or a combination thereof. In the context of software, the blocks represent computer-executable instructions stored in one or more computer-readable storage media that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 5 is a flow diagram illustrating an example process of providing early cancer analysis report based at least in part on user provided data. Moreover, the following actions described with respect to FIG. 5 may be performed by a server, a service provider, a merchant, and/or the cloud server(s) 108, as shown in FIGS. 1-5.

Block 502 illustrates collecting user data. In particular, the cloud server(s) 108 may collect user demographic data 202, CBC data 204, CMP data 206, Lipids data 208, Urinalysis data 210 or any other data may be associated with the predictive purpose. This data may be stored in a database or a data store for subsequent processing and/or analysis.

Block 504 illustrates processing user data. The data processing module 122 may aggregate demographic data 202, CBC data 204, CMP data 206, Lipids data 208, Urinalysis data 210 or any other data at the user level and transform the data.

Block 506 illustrates generating predictive models. More particularly, based at least in part on the aggregated and transformed user data 202-210, the predictive model module 124 of the cloud server(s) may generate and/or maintain predictive models that may be used to determine early cancer risk probabilities for users 102. In other embodiments, the predictive models may utilize one or more algorithms to make such predictions.

Block 508 illustrates comparing and evaluating the early cancer risk probabilities. The analytics module 126 may compare the real-time calculated probabilities by the predictive models 302 for a particular user 102 to the probabilities that are stored in the predictive model 302 to determine the High, Medium or Low risk for the user 102.

Block 510 illustrates generating and delivering the early cancer risk analysis report. In some embodiments, the evaluation report module 128 may generate the early cancer risk analysis report based at least in part on user demographic data (e.g., gender) and the probability comparison results. The early cancer risk analysis report may be delivered to user 102 via a user device 104. More particularly, the early cancer risk analysis report may be provided via an application associated with the user device 104, a site (e.g., website) associated with the Platform 120, messages (e.g., e-mail messages, SMS messages, instant messages, etc.) transmitted to the users 102, and/or any other method of communicating the early cancer risk analysis report to users 102.

Block 512 illustrates updating the predictive models. More particularly, the predictive model(s) may be updated based on the most current user data 204-210 provided by the users 102. For example, as user health condition changes, the basic wellness panel data would change accordingly, the cloud server(s) 108 may continue to collect data indicating such changes and update the predictive models. As a result, the early cancer risk analysis report that may be provided to users 102 may reflect the users 102 current health condition.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method comprising:
Collecting, by the cloud server device, user's demographic and general wellness data that are provided by user who login to the early cancer risk monitoring platform via a network through a user device;
Predicting, by the cloud server device and based at least in part on the user provided data, probabilities of early cancer risk;
Analyzing and evaluating, by the cloud server device, the probabilities of early cancer risk; and
Generating and delivering, by the cloud server device, the early cancer risk analysis report; and
Monitoring, by the user through the device, the risk of multiple cancers based at least in part on the analysis results and gender data.

2. The method as recited in claim 1, wherein the collecting includes user provided demographic data such as age and gender, CBC data, CMP data, Lipids data and Urinalysis data.

3. The method as recited in claim 1, further comprising building predictive models that determine the probabilities of early cancer risk.

4. The method as recited in claim 1, wherein the analyzing and evaluating include using the net lift algorithm to compare and rank the probabilities, and to determine early cancer risk.

5. The method as recited in claim 1, further comprising real-time generating early cancer risk analysis report based on user demographic data and evaluation results and delivering the report to a particular one of the one or more user devices.

6. The method as recited in claim 1, wherein the user can get the analysis report through via one or more user devices to review and monitor early cancer risk.

7. A system comprising: one or more CPU processors, and RAM communicatively coupled to the one of more CPU processors for storing:
A data processing module that aggregates demographic data and basic wellness panel data at user level and transforms the data; and
An analytics module that analyzes the calculated early cancer risk probabilities, compares probabilities between different cancers and users and then rank users by probabilities in each cancer type;
An early cancer risk monitoring platform that dynamical collects user demographic and basic wellness panel data and delivers the early cancer risk analysis report through the user interface to help user monitor early cancer risk.

8. The system as recited in claim 7, wherein the data processing module includes log, fraction and/or square root transformation.

9. The system as recited in claim 7, wherein the data processing module further:
aggregates, demographic, CBC data, CMP data, Lipids data and Urinalysis data at the user level; and
transforms the aggregated data using log, fraction and/or square root.

10. The system as recited in claim 7, wherein the predictive model module includes using predictive models to determine early cancer risk probabilities.

11. The system as recited in claim 7, wherein the probabilities are maintained in one or more tables or lists that include probabilities between a user identifier and the one or more cancers, a cancer identifier and one or more cancers, a gender identifier and one or more cancers.

12. The system as recited in claim 7, wherein the analytics module compares probabilities between different cancers and users and then rank users by probabilities in each cancer type.

13. The system as recited in claim 7, wherein the analytics module includes using a net lift formula.

14. The system as recited in claim 7, wherein the real-time delivering module provides early cancer risk analysis report via an application associated with the particular user device, a web site associated with at least one cancer, or one or more messages transmitted to the particular user device.

15. The system as recited in claim 7, wherein the early cancer risk analysis report are generated and delivered in real-time.

16. One or more computer-readable media having computer-executable instruction that, when executed by one or more processors, performing operations comprising:
collecting the demographic and basic wellness panel data that are provided by users through one or more user devices;
generating predictive models based at least in part on the user provided data.
delivering early cancer risk analysis report via one or more user device utilizing predictive models, the predictive models determining the probabilities between the one or more cancers.
updating the predictive models based at least in part on user demographic data and basic wellness panel data.

17. The computer-readable media as recited in claim 16, wherein the predictive models determining the probabilities using the logistic regression analysis.

18. The computer-readable media as recited in claim 16, wherein the demographic data includes age and gender, basic wellness panel data includes CBC data, CMP data, Lipids data and Urinalysis data.
